(19) United States
(12) Patent Application Publication
(10) Pub. No.: US 2014/0174621 A1
(43) Pub. Date: Jun. 26, 2014

(54) PNEUMATIC TIRE WITH BUILT IN FASTENER SYSTEM

(71) Applicant: The Goodyear Tire & Rubber Company, Akron, OH (US)

(72) Inventors: Daniel Paul Luc Marie Hinque, Habay la Neuve (BE); Anne Therese Peronnet-Paquin, Grand-Duchy (LU); Gilles Bonnet, Niederfeulen (LU); Gauthier Piret, Ster-Francorchamps (BE); William Alain Talbot, Bastogne (BE); Georges Koster, Steinfort (LU)

(73) Assignee: The Goodyear Tire & Rubber Company, Akron, OH (US)

(21) Appl. No.: 13/792,796

(22) Filed: Mar. 11, 2013

Related U.S. Application Data
(60) Provisional application No. 61/740,154, filed on Dec. 20, 2012.

(51) Int. Cl. B60C 19/00

(52) U.S. Cl. CPC B60C 19/00
USPC 152/450; 156/91

(57) ABSTRACT

A pneumatic tire assembly includes a pneumatic tire having an inner cavity and an inner surface at least partially defining the inner cavity, a rigid structure for facilitating operation of the tire assembly, and a threaded receptacle for securing the rigid structure to the inner surface of the inner cavity. The threaded receptacle has been integrally bonded to the inner surface during curing of the pneumatic tire.

### FIELD OF THE INVENTION

The invention relates generally to tires and securing parts to a pneumatic tire.

### BACKGROUND OF THE INVENTION

Structures in a pneumatic tire may require the attaching or securing of certain parts, functional devices, and connectors to a rubber part of the tire (e.g., the innerliner). In particular, the structures of an air maintenance tire typically include components such as pressure regulating valves, check valves, tubing or bridge connectors and filters to be attached to the tire sidewall within the tire cavity. Such structures typically encounter high stresses during the operating conditions of the tire. Thus, strong attachment of such structures is desired for proper operation of the system as a whole.

### SUMMARY OF THE INVENTION

The invention provides in a first aspect a tire comprising: an interior surface, wherein a receptacle is mounted on the interior surface of the tire, the receptacle having a raised hump formed on the interior surface, and having a mechanical fastener system formed within the raised hump.

The invention provides in a second aspect a method of securing an object to a tire, including the steps of: attaching two or more concentric layers of elastomeric material to a green tire; inserting a first part of a mechanical fastener system into a hole of the two or more concentric layers; curing the green tire to form a cured tire and to secure the first part of the two piece mechanical fastening system to the cured tire; attaching the object to a second part of the two piece mechanical fastening system; and attaching the first part of the two-piece mechanical fastening system to the second part of the two-piece mechanical fastening system.

The invention provides in a third aspect a method of securing an object to a tire, including the steps of: attaching two or more concentric layers of elastomeric material to a green tire; molding a first part of a mechanical fastener system into a hole of the two or more concentric layers; curing the green tire to form a cured tire; attaching the object to a second part of the two piece mechanical fastening system; and attaching the first part of the two-piece mechanical fastening system to the molded in second part of the two-piece mechanical fastening system.

The invention provides in a fourth aspect a tire assembly comprising a tire having a toroidal tire cavity for containing pressurized air; an elongate integral air passageway contained within a flexible tire component, the air passageway extending between an air inlet cavity and an air outlet cavity in the flexible tire component, the air passageway extending for at least a partial circumferential path around the tire; and a receptacle mounted on the interior surface of the tire, the receptacle has a first part of a two part fastener system, wherein the receptacle has a passageway in fluid communication with the air passageway within the flexible tire component.

### Definitions

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in section for receipt of an air tube therein.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Peristaltic” means operating by means of wave-like contractions that propel contained matter, such as air, along tubular pathways.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by a shape with adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 illustrates a partial inside view of a tire in the sidewall region showing two threaded receptacles of the present invention.

FIG. 2 illustrates an assembly 112 of concentric rings 114a-g used to form the raised humps 108 of the threaded receptacles of FIG. 1.

FIG. 3 illustrates the assembly placed in a green tire sidewall area.

FIG. 4 illustrates a close-up view of the molded threaded passageway formed in the threaded receptacles 108, 109 post cure.

FIG. 5 illustrates a tire assembly with air maintenance pump assembly.

FIG. 6 illustrates a green tire sidewall during the installation of the pump.

FIG. 7 illustrates a cross-sectional view of a portion of a tire bead area showing the pump tube location.

FIG. 8 illustrates a schematic of the concentric ring assembly mounted on the tire, prior to cure, shown with a screw inserted therein and a strip extending from the tire sidewall to the hole of the concentric ring assembly.

FIG. 9 illustrates a front view of alternate embodiment of the invention.

FIG. 10 illustrates a front view of a second alternate embodiment of the invention.

FIG. 11 is a perspective view of a third alternate embodiment.

FIG. 12 is a cross-sectional view of FIG. 11.

### DETAILED DESCRIPTION OF EXAMPLES OF THE PRESENT INVENTION

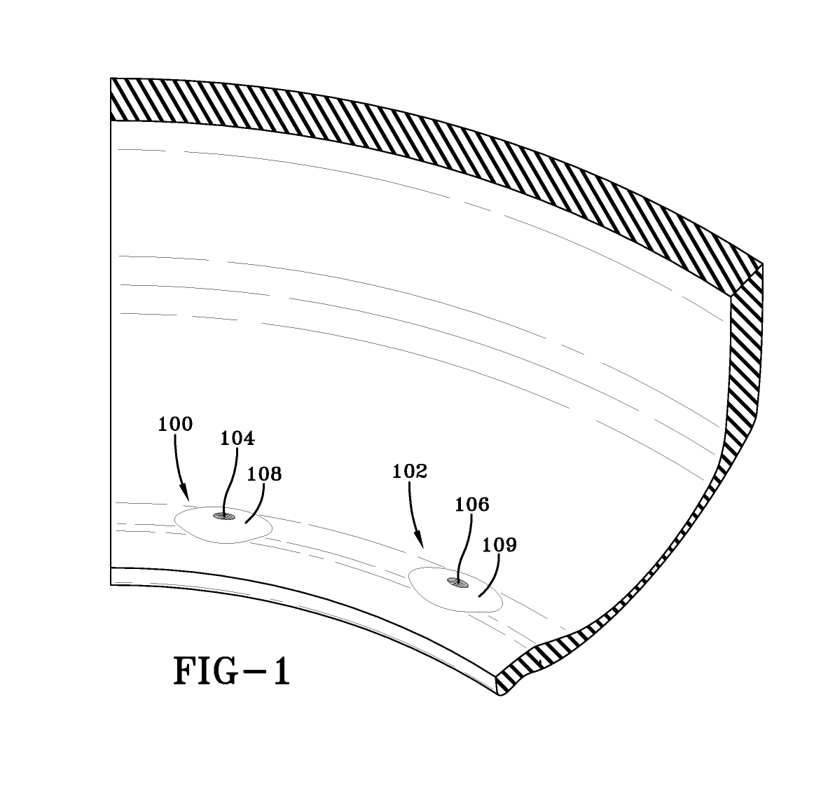

FIG. 1 illustrates a partial inside view of a tire in the sidewall region which illustrates a first and second raised receptacle 100, 102 of the present invention. The raised receptacles 100, 102 are preferably integrally molded with the green tire during vulcanization, and include a raised surface or hump 108, 109 formed on the interior surface of the tire. While the receptacles are shown in the tire sidewall area, the receptacles may be located anywhere on the inside or exterior surface of the tire.

Each raised hump 108, 109 includes a first part of a fastener mechanism which is preferably centrally located. In this example, the first part of a fastener mechanism is a threaded hole 104, 106. Devices such as valves, transducers, filters or other devices have a second part of a fastener system which in this example is a threaded male end, may be secured or screwed into the receptacle as described in more detail, below. The raised receptacle is not limited to a threaded hole, and may include other locking fastener systems known to those skilled in the art. For example, the first part of a fastener mechanism may be a bayonet-style socket that is inserted into the assembly and molded into the tire. The device to be mounted may include the second part of the fastener system which is a bayonet connector for reception into mating engagement with the bayonet socket. Other fastener systems may include snap in fastener, key, spline joint, or retaining ring. Velcro (hook and loop strip) may also be used as the fastener system.

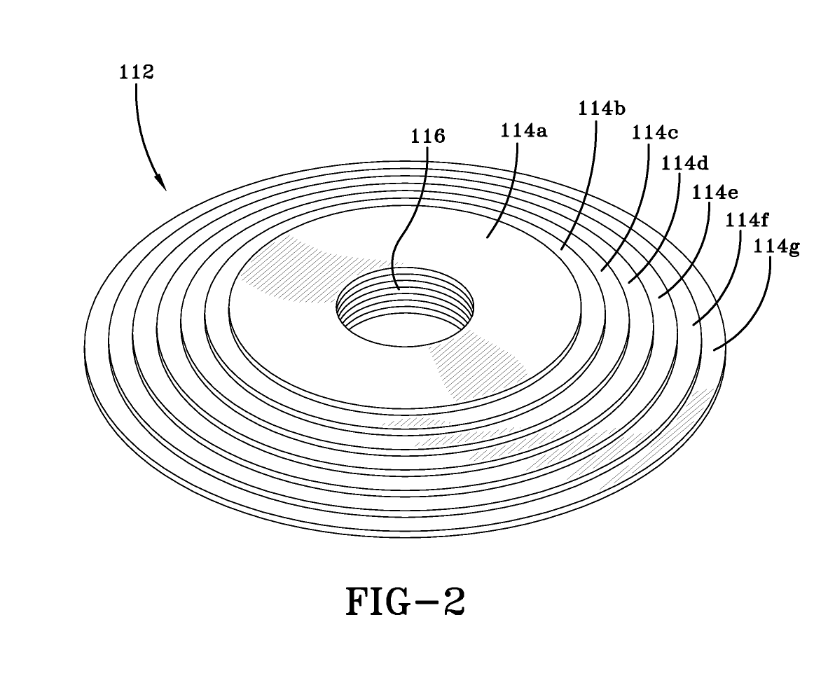

FIG. 2 illustrates an assembly 112 of concentric stacked layers 114a-g used to form the humps 108 of the present invention. While the invention is illustrated as concentric rings, the invention is not limited to the ring shape, as other shapes such as squares, triangles, etc would work for the invention. The assembly 112 is formed of concentric layers of material, wherein the material may be: green rubber or uncured elastomeric or thermoplastic materials or blends thereof. The rubber may be reinforced with short fibers or fabric reinforcements. Preferably, the layers are formed of a green hard rubber compound having a Shore A hardness in the range of about 40 to about 100, and more preferably in the range of about 50 to about 90. Each layer 114a-g has an aligned interior hole 116 having the same interior diameter as the other layers 114a-g. Starting with the innermost layer 114g with the largest outer dimension, the layers 114a-f are arranged in a pyramid with layers of decreasing outer dimensions such that the outermost layer 114a has the smallest outer diameter.

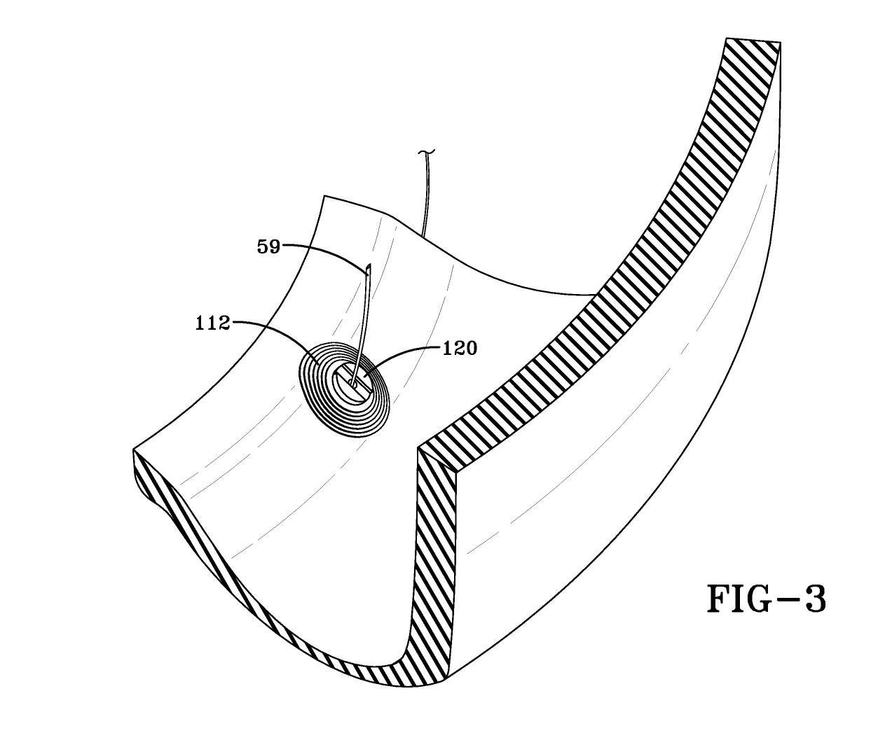

The layers forming the assembly 112 are assembled as shown in FIG. 2 and then placed inside a green tire adjacent the innerliner, as shown in FIG. 3. For an application such as a peristaltic pump assembly, the assembly 112 may be placed in the sidewall area near the chafer. The assembly 112 is temporarily secured to the innerliner using hot gum rubber or rubber adhesive. A screw such as an M5 screw 120 is inserted into hole 116 of the assembly and may be secured using rubber adhesive. The hole diameter 116 is preferably sized so that the hole sidewalls abut the screw surface.

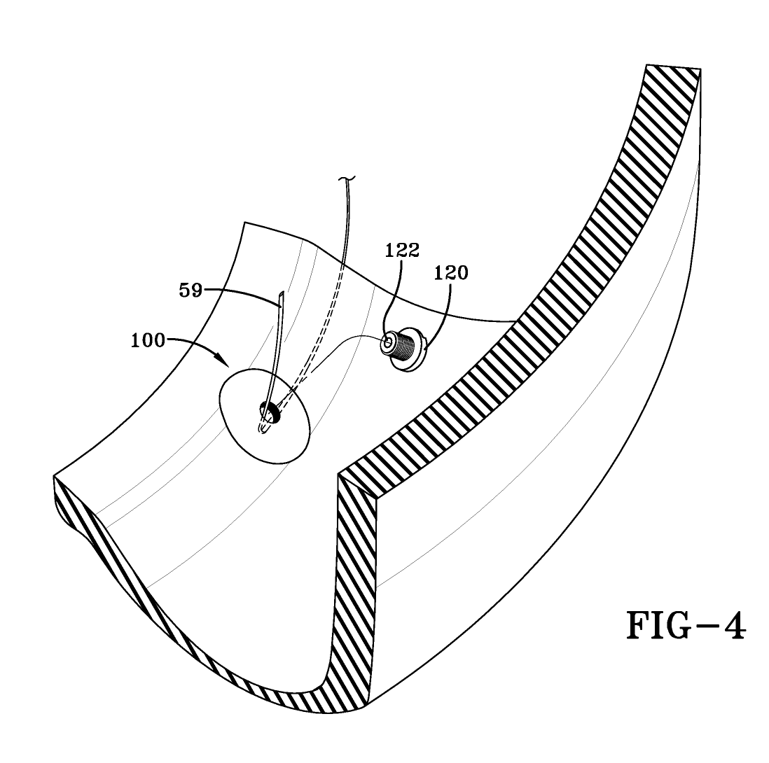

The green tire is then vulcanized in a tire mold as known to those skilled in the art. After the tire has been vulcanized, the concentric assembly has been vulcanized to form the humps 108, 109 which are integrally bonded to the tire inner surface. FIG. 4 illustrates that the threads of the screw 120 has formed a threaded passageway molded in the cured tire after removal of screw 120.

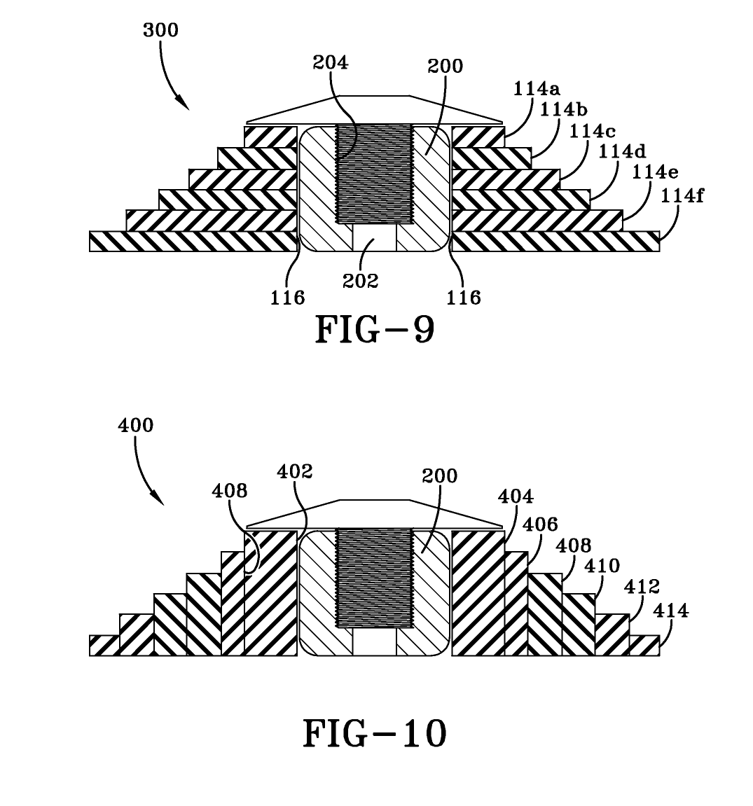

As shown in FIG. 9, the concentric layer assembly 112 may be used in conjunction with an insert 200 forming an assembly 300 which is a first part of a fastener system. The insert 200 may be a cylindrically shaped sleeve having an internal hole 202 (or other fastener mechanism (not shown)). Hole 202 extends completely through the insert 200. The insert 200 is inserted in hole 116 of assembly 112 prior to cure. The insert 200 internal hole 202 preferably is partially threaded 204 to receive a second part of a fastener system such as a threaded end of a valve or other device. The assembly 300 is then affixed to a desired green tire surface such as the internal portion of the sidewall using adhesive. A removable screw is preferably screwed into hole 116 prior to cure. The assembly 300 is permanently molded into the tire with the exception of the removable screw during vulcanization.

The insert 200 may be made of rubber, preferably green rubber, elastomer, metal, plastic, nylon or ultra high molecular weight polyethylene (UHMWPE) or other known material or combinations thereof. The insert may optionally include threads or protrusions on the exterior surface. The insert may further include a flanged outer end (not shown) in order to secure the insert to the tire. The outer surface of the insert may optionally be roughened and coated with a suitable adhesive such as resorcinol formaldehyde latex (RFL) commonly known as “dip”. The outer surface of the insert may further include ridges, flanges, extensions, threads or other mechanical means in addition to the selected RFL to retain it into the rubber of the tire sidewall.

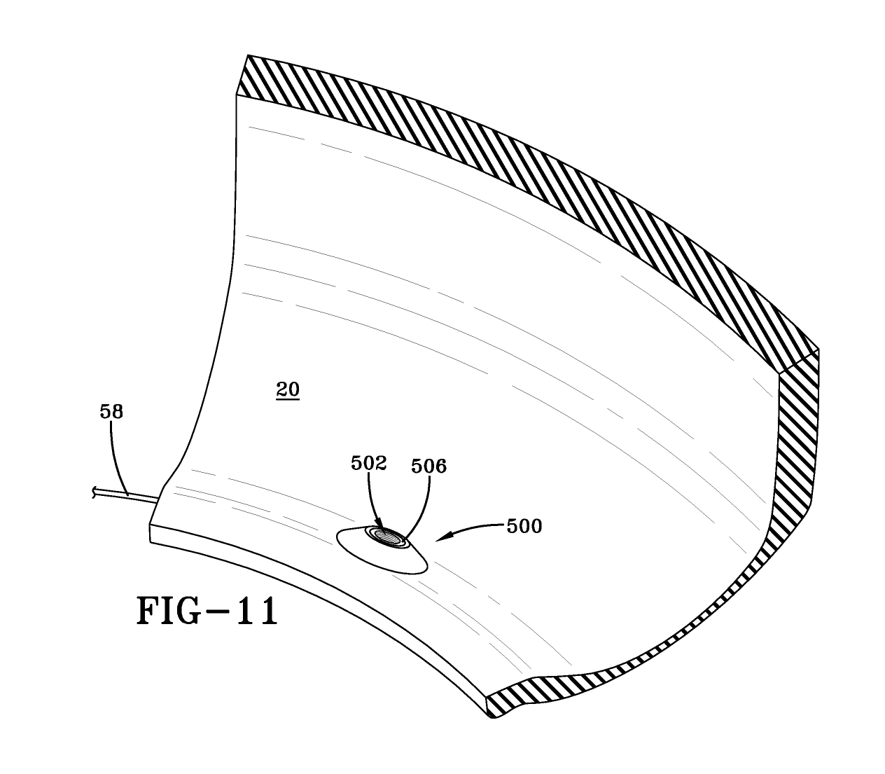

A third embodiment of an assembly 400 is shown in FIG. 10. The assembly includes a plurality of annular rings 404 through 414 wherein each ring has an inner hole which encircles another ring. Thus ring 414 encircles the outer surface of ring 412, and ring 412 has an inner hole which encircles ring 410 and so on. Each ring may have a height H. Preferably the inner most ring 404 is the tallest ring, and the outermost ring is the shortest. The rings are arranged such that the tallest rings are innermost and successively decrease in height towards the outermost ring. The assembly includes an optional insert 200 as described above. The insert is mounted in hole 402 of annular ring 404. Annular rings 404 and 406 are preferably made of a hard rubber such as known to those skilled in the art to form an apex. Rings 408 and 410 are preferably formed of a hard rubber such as a chafer. Rings 412 and 414 are preferably formed of a rubber used to make ply. Thus the innermost rings 404, 406 are formed of a green hard rubber compound having a Shore A hardness in the range of about 40 to about 100, and more preferably in the range of about 50 to about 90.

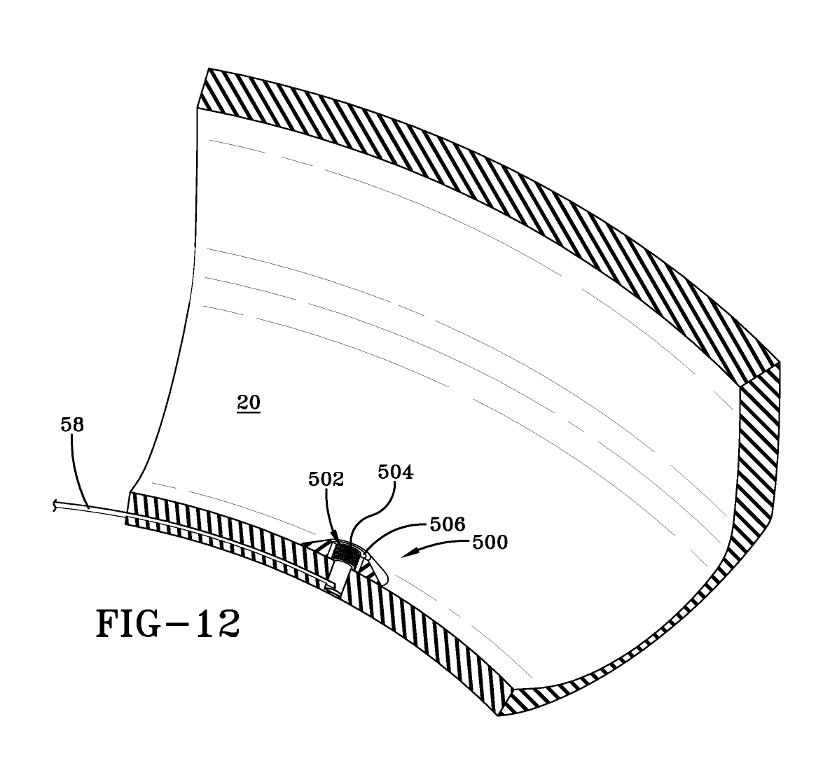

Alternatively, in place of the concentric layered assembly 112, a one piece unit 500 having a pyramidal shape as shown in FIG. 11 may be used. The one piece unit may be premolded to a desired shape such as a pyramid. The one piece unit has a center hole 502 which may be threaded 504. A removable screw may be placed in center hole 502 and used to mold in threads when the assembly 500 is vulcanized in the tire. The one piece unit may optionally include a center sleeve 506 which may be made of a different material than the one piece unit. In place of the screw, a mold to form the shape of the desired fastener may be used, or the fastener device itself may be permanently molded into the tire by insertion prior to cure. The assembly 500 is permanently molded into the tire by affixing to a desired green tire surface such as the internal portion of the sidewall using adhesive. A removable screw is preferably screwed into hole 502 prior to cure. The assembly 500 is permanently molded into the tire with the exception of the removable screw.

The center sleeve may be made of rubber, preferably green rubber, elastomer, metal, plastic, nylon or ultra high molecular weight polyethylene (UHMWPE) or other known material or combinations thereof. The sleeve may optionally include threads or protrusions on the exterior surface. The sleeve may further include a flanged outer end (not shown) in order to secure the sleeve to the tire. The outer surface of the sleeve may optionally be roughened and coated with the selected RFL. The outer surface of the sleeve may further include ridges, flanges, extensions, threads or other mechanical means in addition to the selected RFL to retain it into the rubber of the tire sidewall.

Embodiment with Peristaltic Pump Assembly

The following method steps are applicable for the installation of the threaded receptacle 100 to be used in conjunction with the special case of a tire with a peristaltic pump assembly. The receptacles may be used to install pressure regulators, valves, filter and combinations thereof. Thus, the threaded receptacles must be installed in such a manner so that the devices installed in the receptacles are in fluid communication with the pump fluid passageway in the tire.

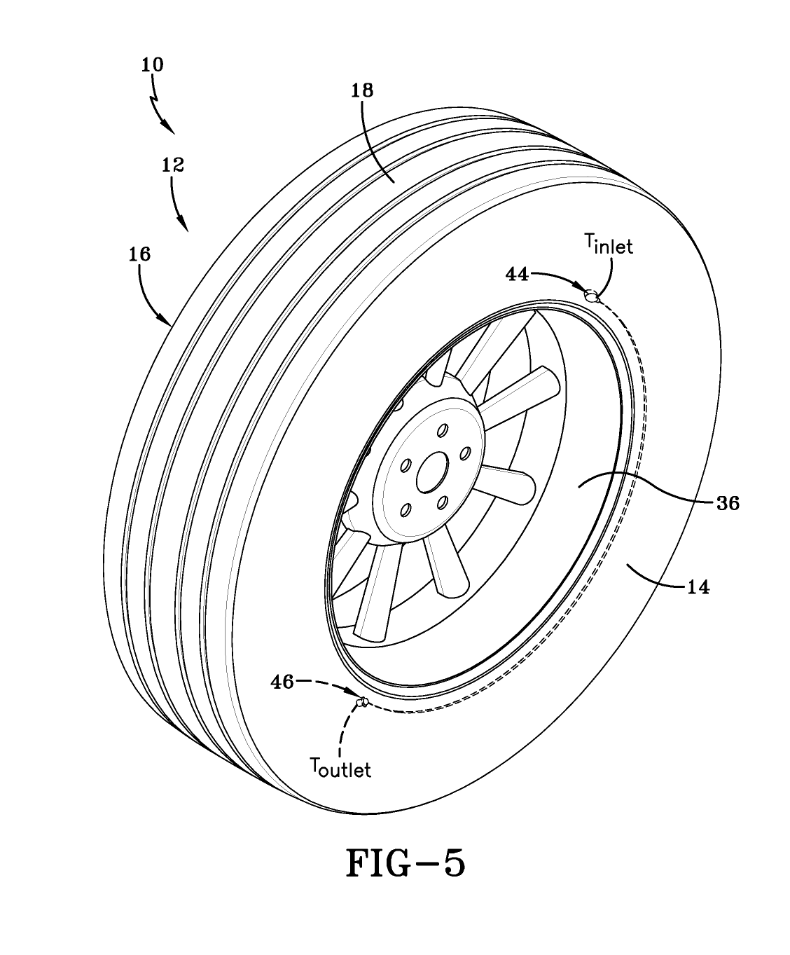

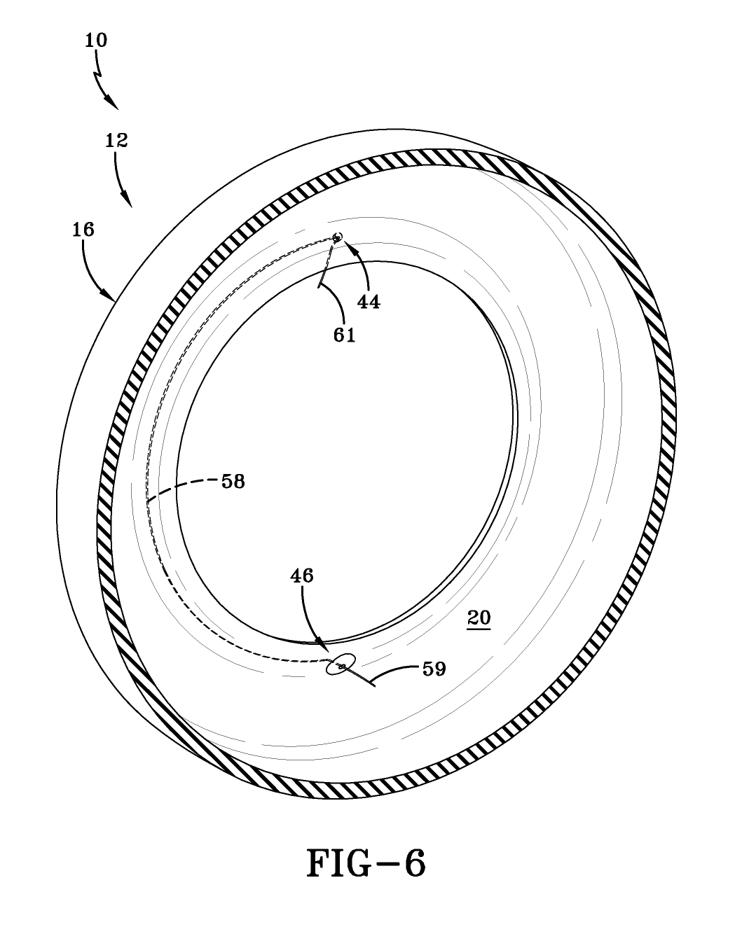

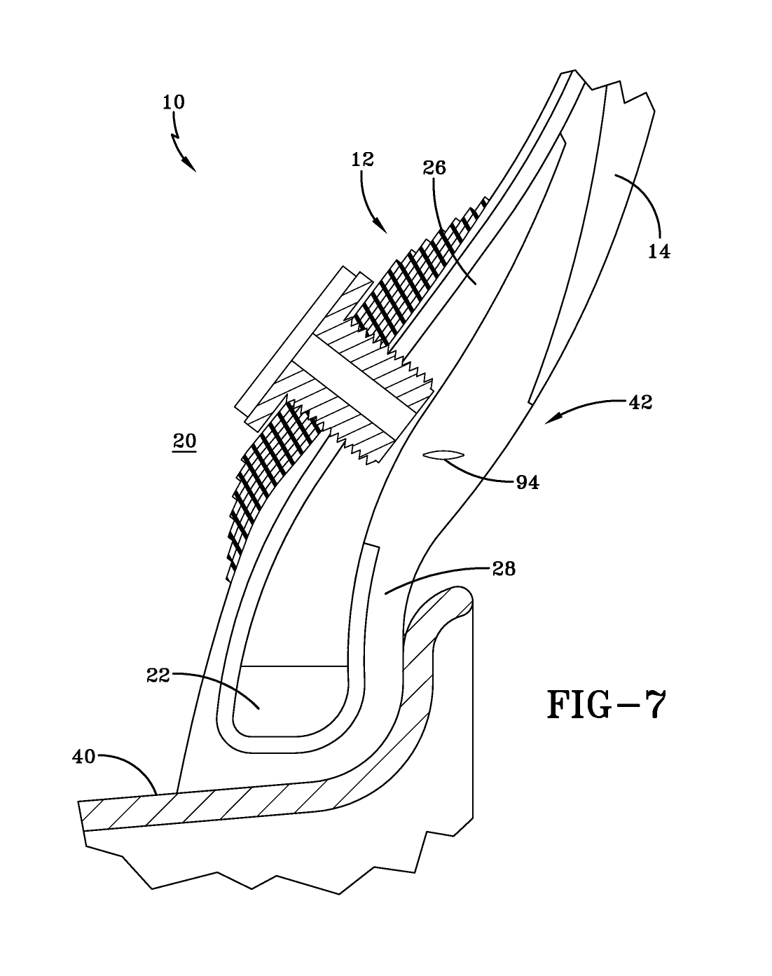

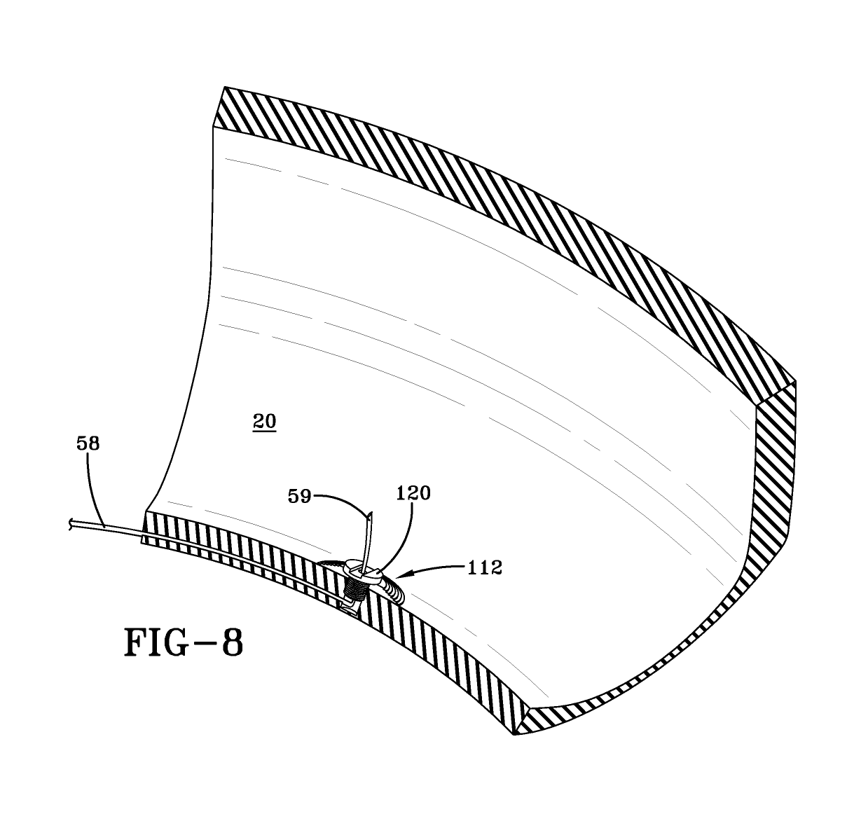

Referring initially to FIG. 5, a tire having an air maintenance assembly system 10 is shown provided within one (FIG. 7) or both (not shown) sidewalls 14, 16 of the tire 12. The air maintenance assembly 42 may be configured to extend between an air entry or inlet cavity 44 and an air exit or outlet cavity 46 within the sidewall 14, 16. The air maintenance assembly 42 may incorporate a thin hollow tube 94 within a flexible tire component, such as the chafer 28, wherein the tube is formed during tire construction with a strip, which is them removed post cure to form the tube 94. The location selected for the hollow tube within the tire 12 may be within a tire component residing within a high flex region of the tire, sufficient to progressively collapse the peristaltic internal hollow tube as the tire rotates under load thereby conveying air along the hollow tube from the inlet cavity 44 to the outlet cavity 46 and the tire cavity 20. This AMT (Air Maintenance Tire) assembly 42 may thus function as an internal peristaltic air pump for the tire 12. The pump is shown as a 180 degree configuration, but could be any desired configuration such as 90 degrees, 270, 360.

A flexible green (uncured) tire component such as a chafer 28, may have a groove formed therein wherein the groove has opposed groove walls. A silicone strip, cable, or wire (hereinafter strip) 58 is placed in the groove between the groove walls, and then the walls stitched closed. The strip may optionally be encased in green rubber prior to placement within the tire component groove. The chafer or tire component with the strip is installed in the tire during the tire building process. Holes are punched in the green tire at the location of the inlet 44 and outlet 46. The strip 58 is preferably dimensioned such that the ends 59, 61 extend a distance beyond the inlet/outlet holes 44, 46 at opposite ends of the chafer strip.

A concentric assembly 112 is positioned at the location of the punched holes 44, 46 on the inside surface of the tire. A first end 59 of the strip is positioned so that it extends through inlet punched hole 46 on the interior surface of the tire, and through hole 116 of concentric ring assembly 112. The threaded end of a screw or other fastener system is positioned in hole 116, wherein the strip end 59 is inserted through a central hole of the screw or fastener system. FIG. 3 illustrates the assembled configuration pre-cure. The procedure is repeated for outlet punched hole 44. It is important that the strip be threaded through each hole 44, 46 and through the central hole 122 of screw 120 in order to form a continuous molded in passageway from each of the threaded receptacles to the pump tube 94. After the tire is cured, the strip is removed forming a continuous air passageway 94 from the threaded receptacle at the inlet end 46, through the interior of the tire sidewall, and to the threaded receptacle at the outlet 48. Preferably, an inlet control or pressure regulator valve (not shown) having a male threaded end is threadably received in the inlet end receptacle. The inlet control valve controls the air flow into the pump. It is also preferred that a check valve having a male threaded end (not shown) is screwed into the receptacle located at the pump outlet end. The check valve is in fluid communication with the tire cavity so that fluid may flow into the tire cavity to maintain the tire pressure at a desired pressure, while preventing cavity air from back flowing into the pump. This continuous air passageway ensures that upon installation of a valve or filter into the threaded receptacle, that the valve, filter or other component is in fluid communication with the pump passageway.

As described above, the air maintenance assembly 42 may represent a peristaltic air pump system in which the compressible air passageway progressively pumps air along the passageway from the inlet to the outlet and the tire cavity 20 for maintaining internal tire cavity pressure at a required level. The inlet and the outlet may be positioned in the range of about 90 to 360 degrees apart, separated by the internal air passageway. The tire 12 may rotate in a direction of rotation and cause a footprint to be formed against the contact/ground surface. A compressive force may be directed into the tire 12 from the footprint and may act to flatten a segment of the air passageway adjacent the footprint. Flattening of the segment of the passageway may force air from the segment along the internal passageway in a direction toward the pump outlet.

The sequential flattening of the air passageway segment by segment may thus cause evacuated air from the flattened segments to be pumped to the pump outlet. When the air flow pressure is sufficient against the permanent outlet assembly, the outlet assembly may open to allow air to flow through the outlet assembly into the tire cavity 20. This air may thereby serve to re-inflate the tire 12 to a desired pressure level as needed.

With the tire 12 continuing to rotate, flattened tube segments may be sequentially refilled by air flowing into the inlet assembly along the passageway. The inflow of air from the inlet may continue until the outlet becomes adjacent the tire footprint. When the tire 12 rotates further, the inlet will eventually pass the tire footprint against ground surface, and airflow may resume to the outlet along the passageway.

The above-described cycle may then be repeated for each tire revolution, “half” depending on the pump length of each rotation resulting in pumped air going to the tire cavity 20 and “half” depending on the pump length of the rotation resulting in pumped air being directed back out the inlet. It will be appreciated that the subject tire assembly and its peristaltic pump assembly 42 may function in like manner in either direction of rotation. The peristaltic pump assembly 42 is accordingly bi-directional and equally functional with the assembly moving in a forward or an opposite, reverse direction of rotation.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire comprising: an interior surface, wherein a receptacle is mounted on the interior surface of the tire, the receptacle having a raised hump formed on the interior surface, and having a first part of a mechanical fastener system formed within the raised hump.

2. The tire of claim 1 wherein the first part of the mechanical fastener system is a threaded passageway.

3. The tire of claim 1 wherein the first part of the mechanical fastener system is a bayonet socket, a snap in fastener, a key, a spline joint or a retaining ring.

4. The tire of claim 1 wherein the first part of the mechanical fastener system is a hook and loop strip.

5. The tire of claim 1 wherein the first part of the mechanical fastener system is an insert.

6. The Tire of claim 1 wherein the insert is made of nylon, brass, metal, plastic or ultra high molecular weight polyethylene.

7. A method of securing an object to a tire, including the steps of: attaching two or more concentric layers of elastomeric material to a green tire; inserting a first part of a mechanical fastener system into a hole of the two or more concentric layers; curing the green tire to form a cured tire and to secure the first part of the two piece mechanical fastening system to the cured tire; attaching the object to a second part of the two piece mechanical fastening system; and attaching the first part of the two-piece mechanical fastening system to the second part of the two-piece mechanical fastening system.

8. A method of securing an object to a tire, including the steps of: attaching two or more concentric layers of elastomeric material to a green tire; molding a first part of a mechanical fastener system into a hole of the two or more concentric layers; curing the green tire to form a cured tire; attaching the object to a second part of the two piece mechanical fastening system; and attaching the first part of the two-piece mechanical fastening system to the molded in second part of the two-piece mechanical fastening system.

9. The tire of claim 8 wherein the first part of the mechanical fastener system is an internal threaded passageway, a bayonet socket, a snap in fastener, a key, a spline joint or a retaining ring.

10. A tire assembly comprising:
a tire having a toroidal tire cavity for containing pressurized air;
an elongate integral air passageway contained within a flexible tire component, the air passageway extending between an air inlet cavity and an air outlet cavity in the flexible tire component, the air passageway extending for at least a partial circumferential path around the tire; and
a receptacle mounted on the interior surface of the tire, the receptacle has a first part of a two part fastener system, wherein the receptacle has a passageway in fluid communication with the air passageway within the flexible tire component.

11. The tire assembly of claim 10 wherein the receptacle is in fluid communication within the tire cavity.

12. The tire assembly of claim 10 wherein a device having a second part of a two part fastener system is secured within the receptacle.

13. The tire assembly of claim 12 wherein the device is a filter having a threaded end that is screwed into the receptacle.

14. The tire assembly of claim 10 wherein the receptacle is raised from the surface of the tire forming a hump.

15. The tire assembly of claim 10 wherein the receptacle further comprises a metal sleeve having a threaded internal passageway.

16. The tire assembly of claim 10 wherein the first part of the mechanical system is a bayonet socket, and the second part is a bayonet.

17. The tire assembly of claim 10 wherein the first part of fastener system is molded into tire.
